(19) United States
(12) Patent Application Publication
(10) Pub. No.: US 2012/0296728 A1
(43) Pub. Date: Nov. 22, 2012

(54) Digital Media Content Delivery System

(75) Inventors: Stephen HUMPHREYS, Miami, FL (US); Granger WHITELAW, Ocean Ridge, FL (US); Richard KANE, Wellington, FL (US); Mario CRUZ, Miami, FL (US)

(73) Assignee: CHOOSE DIGITAL, INC., Coral Gables, FL (US)

(21) Appl. No.: 13/473,193

(22) Filed: May 16, 2012

Related U.S. Application Data
(60) Provisional application No. 61/486,607, filed on May 16, 2011.

(51) Int. Cl. G06Q 30/02

(52) U.S. Cl. 705/14.33; 705/14.27

(57) ABSTRACT

Digital media content is delivered while providing security and solution interoperability. A method for delivering digital content comprises receiving information relating to a user of a loyalty program, the information including a non-monetary balance of the user and a loyalty program status of the user, computing non-monetary prices for a plurality of digital content items based on a monetary value of each digital content item, the loyalty program, and the loyalty program status of the user, and transmitting for display on a user device information representing a digital marketplace, wherein the digital marketplace has been configured to match a look and feel of a loyalty program, and wherein the information representing the digital marketplace includes information relating to at least one digital content item and the information relating to at least one digital content item includes a non-monetary price of the digital content item.

### CROSS-REFERENCE TO RELATED APPLICATIONS

This application claims the benefit of Provisional Application No. 61/486,607, filed May 16, 2011, the contents of which are incorporated herein in their entirety.

### BACKGROUND OF THE INVENTION

1. Field of the Invention

The present invention relates to a system, method, and computer program product for delivering content using digital media while providing security and solution interoperability.

2. Description of the Related Art

The delivery of content using digital media has become the primary means of content distribution. Content of all types—audio, video, graphic, textual, etc.—is now primarily delivered using digital media. Many organizations wish to deliver content using digital media, but have encountered a number of problems. For example, a typical catalog of digital content may include millions of individual digital content items. Each digital content item may have a particular monetary value, which must be paid when the content is delivered. Further, many organizations want to deliver content without specific reference to the monetary value. For example, it may be desired that the content be delivered as a reward or prize in loyalty or frequent user programs. In such programs, it may be desired that value be counted in points or other non-monetary quantities. It may be desired that each program's points may represent a different monetary amount. Even within one program, it may be desired that the represented monetary amount may vary based on a number of factors.

A need arises for a technique by which diverse organizations, with differing point schemes, can deliver a wide variety of digital content easily and inexpensively.

### SUMMARY OF THE INVENTION

A system, method, and computer program product delivers content using digital media while providing security and solution interoperability. Using this technology, diverse organizations, with differing point schemes, can deliver a wide variety of digital content easily and inexpensively.

For example, a method for delivering digital content comprises receiving information relating to a user of a loyalty program, the information including a non-monetary balance of the user and a loyalty program status of the user, computing non-monetary prices for a plurality of digital content items based on a monetary value of each digital content item, the loyalty program, and the loyalty program status of the user, and transmitting for display on a user device information representing a digital marketplace, wherein the digital marketplace has been configured to match a look and feel of a loyalty program, and wherein the information representing the digital marketplace includes information relating to at least one digital content item and the information relating to at least one digital content item includes a non-monetary price of the digital content item. The method may further comprise receiving a selection of a digital content item from among the digital content items displayed in the digital marketplace, delivering the selected digital content item, and deducting from the non-monetary balance of the user the non-monetary price of the selected digital content item. The non-monetary prices may be computed by determining at least one of a user's level segment and tier based on the loyalty program and based on at least one of the user's non-monetary balance in the loyalty program, the user's lifetime non-monetary earnings in the loyalty program, the user's annual non-monetary earnings in the loyalty program, the user's years in the loyalty program, the user's membership type in the loyalty program, and the user's elite loyalty program segment, determining a monetary values to non-monetary prices conversion rate for a user session based on the determined user's level segment, tier, or both, and converting monetary values of each of the plurality of digital content items to non-monetary prices using the determined conversion rate. The digital marketplace may be configured to match a look and feel of the loyalty program by configuring aspects of the digital marketplace design, including at least one of colors, shapes, layout, and typefaces of the digital marketplace design to match corresponding aspects of the loyalty program, and by configuring aspects behavior of dynamic elements of the digital marketplace including at least one of buttons, boxes, and menus to match corresponding aspects of the loyalty program.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary flow diagram of a process of content delivery using digital media.

FIG. 2 is an exemplary overview of a digital content delivery system.

FIG. 3 shows an exemplary implementation of a Digital Marketplace website or application.

FIG. 4 is an exemplary block diagram of an Application Programming Interface.

FIG. 5 is exemplary flow diagram of a process of converting monetary values of content to point/miles prices using tiering.

FIG. 6 is an exemplary block diagram of a computer system, in which a digital content delivery system may be implemented

### DETAILED DESCRIPTION OF THE INVENTION

A system, method, and computer program product delivers content using digital media while providing security and solution interoperability. Using this technology, diverse organizations, with differing point schemes, can deliver a wide variety of digital content easily and inexpensively.

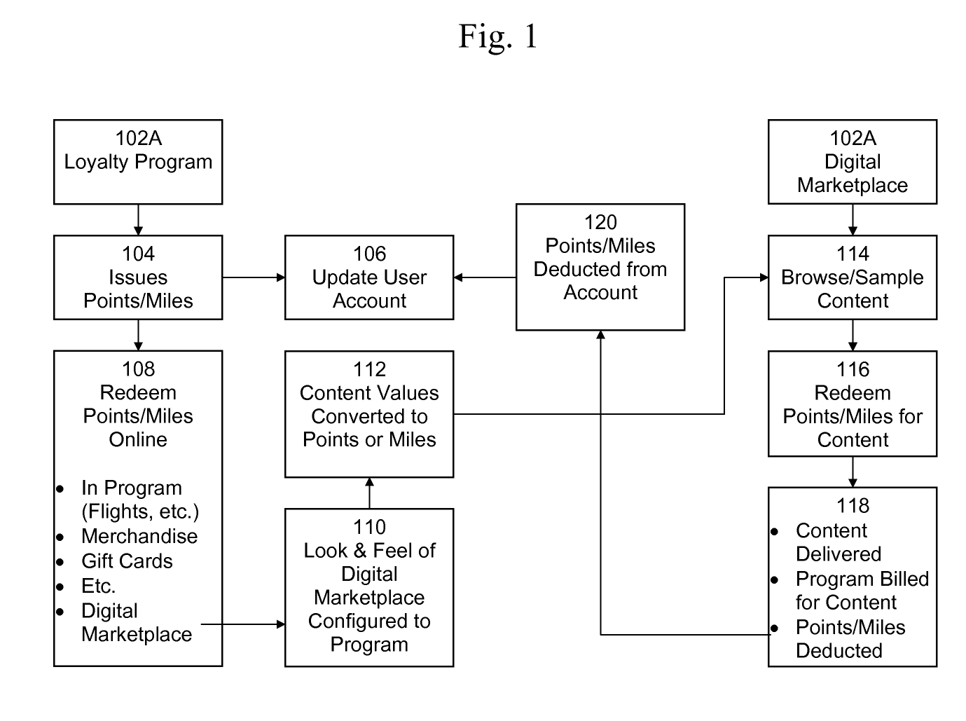

An exemplary flow diagram of a process 100 of content delivery using digital media is shown in FIG. 1. Process 100 begins with step 102A, in which a user logs in to a website or application of loyalty, frequent user, reward, incentive, or other such program (all of which are referred to hereinafter as “loyalty programs”). Alternatively, in step 102B, a user may log in to a website or application of a digital marketplace itself. The user may login using any type of user device that is capable of displaying a website or running an application. Examples of such user devices may include computer systems, smartphones, tablet computers, etc. Assuming that the process has started with step 102A, the process continues with step 104, in which the operator of the loyalty program issues points, miles or other quantities of value (all of which are referred to hereinafter as a “points/miles”) to the user and, in step 106, updates the user's account by crediting the points/miles to the user's account.

In step 108, the user proceeds to redeem some or all of the points/miles in their account online, using the website or application of the loyalty program. Typical points/miles redemption rewards or prizes include in program rewards, such as flights from an airline loyalty program, merchandise, gift cards, digital content, etc. These are merely examples of possible redemption rewards. The present invention contemplates any and all types of redemption rewards that may be offered. In the case that the user selects a redemption reward of digital content, the user that is logged in to the website or application of the loyalty program is directed to a website or application that is provided by the digital content delivery system. The website or application may hosted on the digital content delivery system, or the website or application may be hosted on a system of the loyalty program provider, which communicates with the digital content delivery system.

In any case, in step 110, the look and feel of the digital marketplace that is presented to the user is configured to the requirements of the loyalty program provider. The look and feel of the digital marketplace relates to the graphical user interface of the digital marketplace and comprises aspects of its design, including elements such as colors, shapes, layout, and typefaces (the “look”), as well as the behavior of dynamic elements such as buttons, boxes, and menus (the “feel”). The digital marketplace may be configured to match the look and feel of the website or application of the loyalty program provider; it may be configured to some other specified look and feel, or it may be configured to the default look and feel of the digital marketplace.

In step 112, the monetary values of the content are converted to non-monetary values such as points/miles prices. This may be done using a simple conversion factor, or it may be done using tiering based on the user's level, the user's point balance, ongoing promotions, etc. In step 114, the user uses the website or application to browse, search for, and sample content presented by the digital content delivery system. A variety of information about digital content item may be presented to the user, including information such as the point/miles price of the content, the title, the creators, the artists, the genre, graphics associated with the content, etc.

In step 116, the user selects one or more digital content items for which to redeem their points. This may be done, for example, using a conventional shopping cart mechanism, but in which the prices and totals due are in points/miles, rather than in monetary units. In step 118, step 118, the content is delivered to the user, the loyalty program is billed for the content delivered, and the point/miles are deducted from the user's account with the loyalty program. For example, the content may delivered to the user by direct download from the digital content delivery system, or by other means, such as an emailed link, etc. The loyalty program may be billed, for example, upon delivery of each digital content item, or, the loyalty program may be billed periodically or when the amount due exceeds a threshold. In order to deduct points/miles from the user's loyalty program account, the process goes to step 120, which performs the necessary processing to access the user's loyalty program account and cause update step 106 to deduct the correct amount of points/miles from the user's loyalty program account.

In the case that the process has started with step 102B, the process continues with step 114. Optionally, step 110 may be performed before step 114, in order to configure the look and feel of the digital marketplace to the requirements of the loyalty program provider.

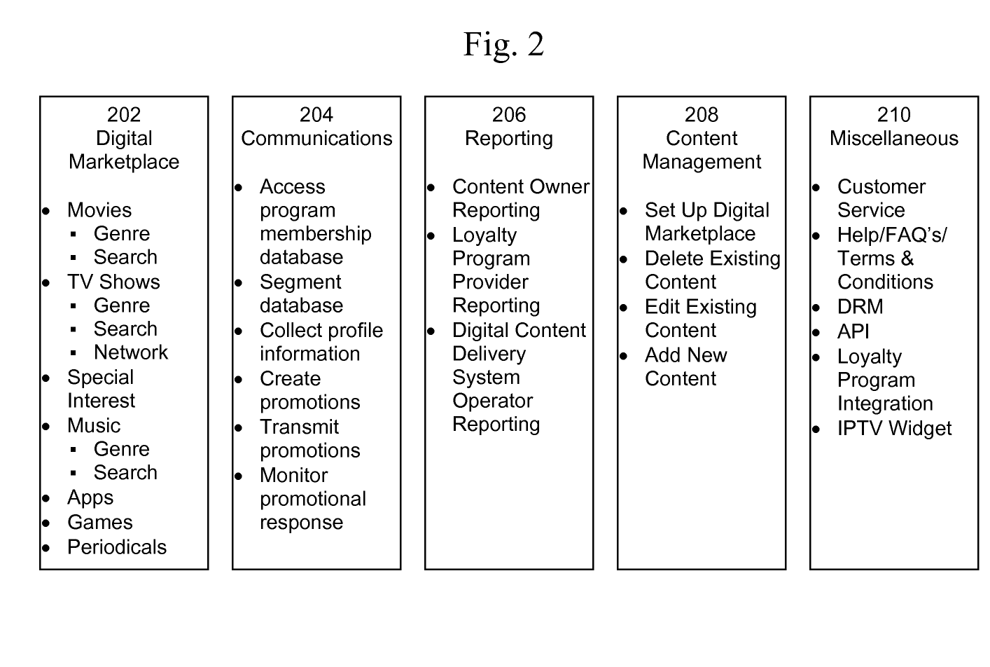

An exemplary overview of a digital content delivery system is shown in FIG. 2. Key areas of functionality of the digital content delivery system are shown. The major functional areas include the digital marketplace 202, the communications modules 204, the reporting modules 206, the content management modules 208, and miscellaneous modules 210.

The digital marketplace 202 is one or more implementations of an online store where users will be able to browse and sample the available digital content. Typically, digital marketplace 202 is accessed via a click thru from the host incentive program e.g. ‘redeem points for movies, music, Apps’. The experience will be seamless in that the user will not be aware that they have left the site of the incentive program, as shown in FIG. 1. The digital marketplace 202 will have the ability to run promotional messages on the store front, such as special offers, new releases, clicking thru direct to promoted download, etc.

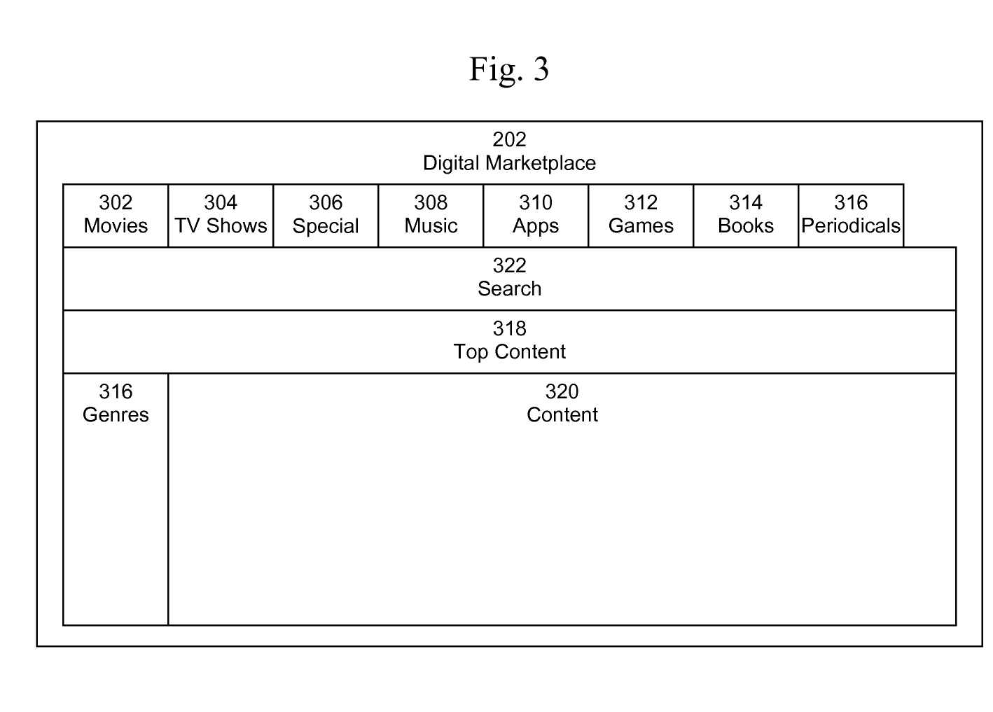

In the exemplary implementation shown in FIG. 3, digital marketplace 202 is divided into tabbed sections such as movies tab 302, TV shows tab 304, special interest tab 306, music tab 308, apps tab 310, games tab 312, books tab 314, and periodicals tab 316. As an example, within movie tab 302 there are shown a further series of tabs by genre 316, such as family, action, adult, children, classics, new releases, favorites, etc. The user can click thru to the titles under any of these genres. There is a top content area 318, such as view by Top 20 genres, latest releases, most popular, etc. Under genres in content area 320 there is shown a visual of the movies, such as the front cover of the DVD/promotional shot plus movie title. Clicking on a specific movie title or image will display additional information, such as a visual of the movie i.e. the cover shot of the DVD or promotional shot of the movie, a text description of the movie (title, date, director, main stars, brief plot overview, etc.), reviews—voting on 5 stars plus written comments, controls for showing a trailer of the movie, the points/miles cost for each item, the options for downloading the movie—rental, full download, etc., controls to select and purchase the content, etc. There is also a search functionality 322 by key word, movie title, genre, date, etc.

Other tabs display similar information. For example, TV Shows tab 304 displays similar information to movie tab 302. In addition, TV channel/network e.g. NBC, ABC, CBS, etc. information is displayed. Programs are available as individual episodes, seasons, or entire series. Special Interest tab displays similar information, but covers special interest subjects such as sport, nature, concerts, etc. Music tab 308 displays similar information, such as a further series of tabs by genre—rock, dance, country, etc. Under genres there is a visual of the album cover plus title. The user can click thru to the titles under any of these genres. Clicking on a specific album will display a visual of the album, a text description (artist, title, date, director, label, etc.). There are also a view by Top 20 genres, latest releases, most popular, etc., reviews—voting on 5 stars plus written comments, short samples of the tracks, options for downloading—by track, the entire album or video, point cost for each item, controls to select and purchase the content, etc. There is also a search functionality by key word—genre, artist, song, etc.

Another example of a tab is Apps tab 310, which displays an application store, such as the Android Marketplace or the like. The application store may display information, such as a series of further tabs, such as a Featured tab, a Top Paid tab, a Top Free tab, and a search by genre tab (e.g. Games, Business, Travel, etc), and individual apps. Clicking on an App may display more tabs, such as an Overview tab, a User Reviews tab, an App screenshots tab, and an About this App tab. Pricing in points/miles would be displayed. Upon the user selecting to install and App, a confirmation message with points to be deducted would be displayed, optionally with follow up email confirmation.

Additional exemplary tabs may include Games tab 312, which may include games not already included under Apps tab 310, Book tab 314, which may include eBooks & audiobooks, Periodicals tab 316, which may include magazines, newspapers, etc., and other tabs, not shown, such as an Instructional tab, which may include instructional videos, such as golf, tennis, speaking a new language, etc.

Communications modules 204, shown in FIG. 2, provide functionality to run promotions to the members of loyalty programs. For example, a promotion might advertise “Advance purchase the new Artist album and get it one day early”. Examples of basic functionality may include the capability to access the loyalty program membership database, segment the database based on basic profile information, such as age, sex, activity levels, previous purchases, etc., and the capability to collect profile information about members and add it back to the loyalty program database, including information about purchase behaviors, etc. If the loyalty program provider will not allow outside modification of data to their database, then the database may be mirrored in the digital content delivery system, including taking regular updates and building its own profile information for promotional purposes. Additional functionality may include the capability to create a promotion, such as in a standard email template with the details of the offer and a link to directly purchase the offered item, the capability to transmit promotions, such as by text message, email, social media, etc, and to monitor response to promotions and collect profile data for future promotions.

Reporting modules 206, shown in FIG. 2, provide functionality to provide system operation reports and statistics. Examples of types of reporting that may be provided include content owner reporting, loyalty program provider reporting, and digital content delivery system operator reporting. Content owner reporting may provide the capability to monitor downloads for content owners and report back to them. These reports may be customized to content owner requirements. The capability for online access to reports and the ability to set up regular reporting procedures, such as weekly, monthly, etc., may be provided. Loyalty program provider reporting may include the capability to provide reports showing download levels, values, volumes, profile data, top downloads, etc. These reports may be customized to loyalty program provider requirements. Digital content delivery system operator reporting may include the capability to provide reports for billing, reconciling payments to content owners, success of promotional campaigns, customer service reports to monitor customer query levels, resolutions and escalations, etc.

Content Management modules 208, shown in FIG. 2, provides functionality to manage the content hosted in the digital content delivery system. Examples of capability provided may include digital marketplace set up, the capability to delete existing content, the capability to edit existing content—change visual image, descriptions, point pricing, terms, the capability to add new content, etc.

Miscellaneous modules 208, shown in FIG. 2, provides functionality to perform a variety of additional functions, such as customer service, Help/FAQ's/Terms &Conditions, Digital Rights Management (DRM), Loyalty Program Integration, such as an Application Programming Interface (API) and Look & Feel configuration tools, and an IPTV widget.

Customer service support handles queries directly relating to content downloads, technical difficulties, etc. Customer service will captures queries relating to the host loyalty programs handed-off back to the loyalty program provider. Capabilities provided may include logging queries, with time and date stamp, maintaining action audit trails, closing queries, escalating or handing-off protocols to incentive programs, generating appropriate reports, etc. Help/FAQ's/Terms &Conditions capabilities may be provided to users to aid in using the system. DRM capabilities may be provided for that content which requires it.

Loyalty Program Integration provides functionality for integrating with loyalty programs. Such functionality may include an API and Look & Feel configuration tools. The API is software that provides a programming interface to the functionality of the digital content delivery system. a specification intended to be used as an interface by software components to communicate. The provides the capability to connect seamlessly to loyalty programs, allowing program members to seamlessly to access the Digital Marketplace, browse and download content. Functionality provided by the API may include, upon a user making a purchase, the API ascertains whether the user has sufficient points in their account to complete the transaction, hold the points while the download is set up, and deduct the points from the member account when complete. Additional functionality may include accessing of loyalty program member database or parts of the database, and to information such as points/miles balance, email addresses, profile information, etc. to complete transactions and create promotions.

Look & Feel configuration tools provide the capability to configure the display of the Digital Marketplace website so that it looks and feels, as far as possible, like the host loyalty program site.

An IPTV widget is a light-weight app that can be downloaded to an IPTV. The widget would allow members to browse content of the Digital Marketplace directly on their IPTV's and make purchases using points from the host incentive program.

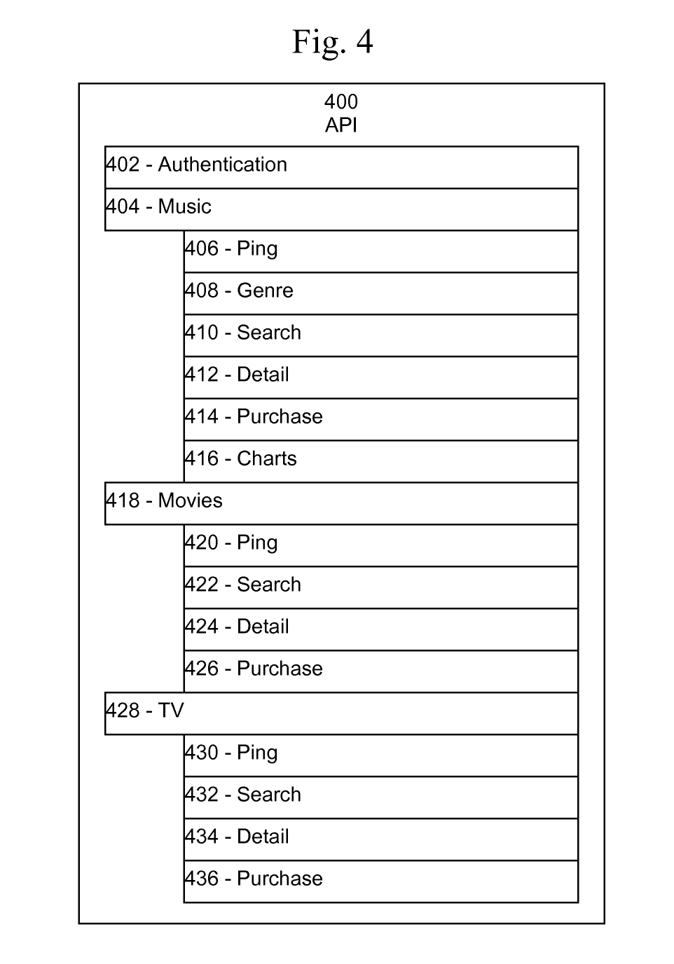

An example of an API 400 such as that shown in FIG. 2 is shown in FIG. 4. API 400 may include a number of functional categories, such as authentication 402, music 404, movies 418, and TV 428. Authentication category 402 involves required headers that are added to every request to ensure that the request is from the identified user and that that user is authorized to perform the requested action. Music category 404 includes functionality relating to music content. Such functionality may include a ping request, which is a check to make sure authentication is working properly and that the service is up, a genre request, which returns all valid genres, a search request, which performs a search by keyword, country, artist, genre, and release type, and which can sort by field, a detail request, which returns details of a specific digital content item, a purchase request, which performs a purchase transaction, and a charts request, which retrieves defined categories of content, such as staffpicks, latest, top, upcoming, may also include criteria such as genre, country, release type, etc. Movie category 404 includes functionality relating to movie content. Such functionality may include a ping request, which is a check to make sure authentication is working properly and that the service is up, a Search request, which performs a search by keyword and country, and which can sort by field, a detail request, which returns details of a specific digital content item, and a purchase request, which performs a purchase transaction. TV category 404 includes functionality relating to TV content. Such functionality may include a ping request, which is a check to make sure authentication is working properly and that the service is up, a search request, which performs a search by keyword and country, and which can sort by field, a detail request, which returns details of a specific digital content item, and a purchase request, which performs a purchase transaction.

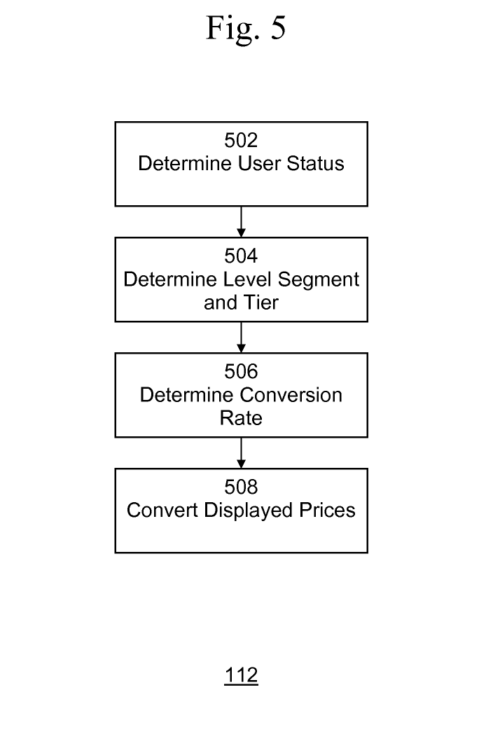

In step 112, shown in FIG. 1, the monetary values of the content are converted to point/miles prices. This may be done using a simple conversion factor, or it may be done using tiering based on the user's level, the user's points/miles balance, ongoing promotions, etc. An example of a process of converting monetary values of content to point/miles prices using tiering is shown in FIG. 5. The process begins with step 502, in which the user's status is determined. For example, the user's status may be determined by retrieving the status from the loyalty program, by calculating the user's status based on user profile information, such as the user's point/miles balance, lifetime point/miles earned, annual point/miles earned, years in the loyalty program, membership type, etc. In step 504, the user's level segment and tier is determined. For example, using the user status information from step 502, the user may be categorized into one of several level segments, and within the level segment, into a particular tier. For example, based on a user's annual point/miles earned, the user may be categorized into an elite loyalty program segment, such as silver, gold, or platinum, and then based on the user's lifetime point/miles earned, years in the loyalty program, and or membership type, the user may be categorized into a low, medium, or high tier.

In step 506, the monetary values to point/miles prices conversion rate for the user session is determined. For example, using the user's level segment and tier determined in step 504, a database of conversion rates may be accessed to obtain the conversion rate for the user session. In step 508, the monetary content prices are converted using the conversion rate determined in step 506. These converted prices are then used in the digital marketplace for display to the user. For example, a user may be able to view available content or promotions before logging in to the loyalty program or digital content delivery system. In this case, the default or full price of the content may be displayed. Once the user logs in, the prices displayed to that user may be converted according to the process shown in FIG. 5.

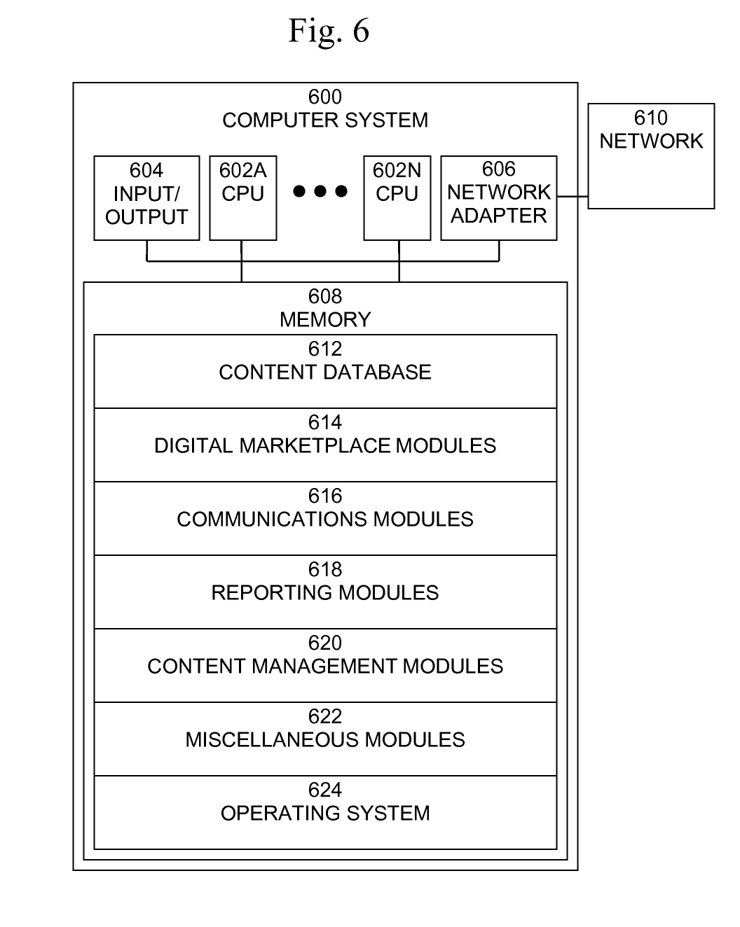

An exemplary block diagram of a computer system 600, in which a digital content delivery system may be implemented, is shown in FIG. 6. System 600 is typically a programmed general-purpose computer system, such as a personal computer, workstation, server system, or minicomputer or mainframe computer. System 600 includes one or more processors (CPUs) 602A-602N, input/output circuitry 604, network adapter 606, and memory 608. CPUs 602A-602N execute program instructions in order to carry out the functions of the present invention. Typically, CPUs 602A-602N are one or more microprocessors, such as an INTEL PENTIUM® processor. FIG. 6 illustrates an embodiment in which System 600 is implemented as a single multi-processor computer system, in which multiple processors 602A-602N share system resources, such as memory 608, input/output circuitry 604, and network adapter 606. However, the present invention also contemplates embodiments in which system 600 is implemented as a plurality of networked computer systems, which may be single-processor computer systems, multi-processor computer systems, or a mix thereof.

Input/output circuitry 604 provides the capability to input data to, or output data from, database/system 600. For example, input/output circuitry may include input devices, such as keyboards, mice, touchpads, trackballs, scanners, etc., output devices, such as video adapters, monitors, printers, etc., and input/output devices, such as, modems, etc. Network adapter 606 interfaces device 600 with network 610. Network 610 may be any standard local-area or wide-area communications or tele-communications network, whether wired or wireless, or public, private, or proprietary. Typically network 610 may include the Internet, along with one or more other networks.

Memory 608 stores program instructions that are executed by, and data that are used and processed by, CPU 602 to perform the functions of system 600. Memory 608 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 608 vary depending upon the function that system 600 is programmed to perform. In the example shown in FIG. 6, memory 608 includes content database 612, digital marketplace modules 614, communications modules 616, reporting modules 618, content management modules 620, miscellaneous modules 622, and operating system 624. Content database 612 include content files, such as music, movies, TV shows, etc., related information such as title, genre, artist, etc., that provides relevant facts about the content and software routines which provides the capability to search for particular content using the related information. Digital marketplace modules 614 include software routines and data that are used to provide the functionality and look & feel of a digital marketplace. Communications modules 616 include software routines and data that are used provide functionality to run promotions to the members of loyalty programs. Reporting modules 618 include software routines and data that are used provide functionality to provide system operation reports and statistics. Content Management modules 620 include software routines and data that are used provide functionality to manage the content hosted in the digital content delivery system. Miscellaneous modules 622 include software routines and data that are used provide functionality to perform a variety of additional functions, such as customer service, Help/FAQ's/Terms &Conditions, Digital Rights Management (DRM), Loyalty Program Integration, such as an Application Programming Interface (API) and Look & Feel configuration tools, and an IPTV widget. Operating system 624 provides overall system functionality.

As shown in FIG. 6, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a non-transitory computer readable medium of instructions and a variety of forms and that the present invention applies equally regardless of the particular type of media actually used to carry out the distribution. Examples of non-transitory computer readable media include, but are not limited to, floppy disks, hard disk drives, CD-ROMs, DVDROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for delivering digital content comprising:
receiving information relating to a user of a loyalty program, the information including a non-monetary balance of the user and a loyalty program status of the user;
computing non-monetary prices for a plurality of digital content items based on a monetary value of each digital content item, the loyalty program, and the loyalty program status of the user; and
transmitting for display on a user device information representing a digital marketplace, wherein the digital marketplace has been configured to match a look and feel of a loyalty program, and wherein the information representing the digital marketplace includes information relating to at least one digital content item and the information relating to at least one digital content item includes a non-monetary price of the digital content item.

2. The method of claim 1, further comprising:
receiving a selection of a digital content item from among the digital content items displayed in the digital marketplace;
delivering the selected digital content item; and
deducting from the non-monetary balance of the user the non-monetary price of the selected digital content item.

3. The method of claim 2, wherein the non-monetary prices are computed by:
determining at least one of a user's level segment and tier based on the loyalty program and based on at least one of the user's non-monetary balance in the loyalty program, the user's lifetime non-monetary earnings in the loyalty program, the user's annual non-monetary earnings in the loyalty program, the user's years in the loyalty program, the user's membership type in the loyalty program, and the user's elite loyalty program segment;
determining a monetary values to non-monetary prices conversion rate for a user session based on the determined user's level segment, tier, or both; and
converting monetary values of each of the plurality of digital content items to non-monetary prices using the determined conversion rate.

4. The method of claim 3, wherein:
the digital marketplace has been configured to match a look and feel of the loyalty program by configuring aspects of the digital marketplace design, including at least one of colors, shapes, layout, and typefaces of the digital marketplace design to match corresponding aspects of the loyalty program, and by configuring aspects behavior of dynamic elements of the digital marketplace including at least one of buttons, boxes, and menus to match corresponding aspects of the loyalty program.

5. A computer program product for delivering digital content comprising:
a non-transitory computer readable medium having recorded thereon computer program instructions, the computer program instructions executable by at least one processor to:
receive information relating to a user of a loyalty program, the information including a non-monetary balance of the user and a loyalty program status of the user;
compute non-monetary prices for a plurality of digital content items based on a monetary value of each digital content item, the loyalty program, and the loyalty program status of the user; and
transmit for display on a user device information representing a digital marketplace, wherein the digital marketplace has been configured to match a look and feel of a loyalty program, and wherein the information representing the digital marketplace includes information relating to at least one digital content item and the information relating to at least one digital content item includes a non-monetary price of the digital content item.

6. The computer program product of claim 5, further comprising computer program instructions executable to:
receive a selection of a digital content item from among the digital content items displayed in the digital marketplace;
deliver the selected digital content item; and
deduct from the non-monetary balance of the user the non-monetary price of the selected digital content item.

7. The computer program product of claim 6, wherein the non-monetary prices are computed by:
determining at least one of a user's level segment and tier based on the loyalty program and based on at least one of the user's non-monetary balance in the loyalty program, the user's lifetime non-monetary earnings in the loyalty program, the user's annual non-monetary earnings in the loyalty program, the user's years in the loyalty program, the user's membership type in the loyalty program, and the user's elite loyalty program segment;
determining a monetary values to non-monetary prices conversion rate for a user session based on the determined user's level segment, tier, or both; and
converting monetary values of each of the plurality of digital content items to non-monetary prices using the determined conversion rate.

8. The computer program product of claim 7, wherein:
the digital marketplace has been configured to match a look and feel of the loyalty program by configuring aspects of the digital marketplace design, including at least one of colors, shapes, layout, and typefaces of the digital marketplace design to match corresponding aspects of the loyalty program, and by configuring aspects behavior of dynamic elements of the digital marketplace including at least one of buttons, boxes, and menus to match corresponding aspects of the loyalty program.

9. A system for delivering digital content comprising a processor operable to execute computer program instructions, a memory operable to store computer program instructions executable by the processor, and computer program instructions stored in the memory and executable to:
receive information relating to a user of a loyalty program, the information including a non-monetary balance of the user and a loyalty program status of the user;
compute non-monetary prices for a plurality of digital content items based on a monetary value of each digital content item, the loyalty program, and the loyalty program status of the user; and
transmit for display on a user device information representing a digital marketplace, wherein the digital marketplace has been configured to match a look and feel of a loyalty program, and wherein the information representing the digital marketplace includes information relating to at least one digital content item and the information relating to at least one digital content item includes a non-monetary price of the digital content item.

10. The system of claim 9, further comprising computer program instructions executable to:
receive a selection of a digital content item from among the digital content items displayed in the digital marketplace;
deliver the selected digital content item; and
deduct from the non-monetary balance of the user the non-monetary price of the selected digital content item.

11. The system of claim 10, wherein the non-monetary prices are computed by:
determining at least one of a user's level segment and tier based on the loyalty program and based on at least one of the user's non-monetary balance in the loyalty program, the user's lifetime non-monetary earnings in the loyalty program, the user's annual non-monetary earnings in the loyalty program, the user's years in the loyalty program, the user's membership type in the loyalty program, and the user's elite loyalty program segment;
determining a monetary values to non-monetary prices conversion rate for a user session based on the determined user's level segment, tier, or both; and
converting monetary values of each of the plurality of digital content items to non-monetary prices using the determined conversion rate.

12. The system product of claim 11, wherein:
the digital marketplace has been configured to match a look and feel of the loyalty program by configuring aspects of the digital marketplace design, including at least one of colors, shapes, layout, and typefaces of the digital marketplace design to match corresponding aspects of the loyalty program, and by configuring aspects behavior of dynamic elements of the digital marketplace including at least one of buttons, boxes, and menus to match corresponding aspects of the loyalty program.
